(19) United States
(12) Patent Application Publication
(10) Pub. No.: US 2010/0126102 A1
(43) Pub. Date: May 27, 2010

(54) Hollow Profiled Element, Particularly for a Lattice Tower; Method for the Production of Such a Hollow Profiled Element; Lattice Tower Comprising at Least Three Corner Posts

(76) Inventor: Hermann Oehme, Lubeck (DE)

Correspondence Address: RANKIN, HILL & CLARK LLP, 38210 Glenn Avenue, WILLOUGHBY, OH, 44094-7808, US

(21) Appl. No.: 12/514,875

(22) PCT Filed: Nov. 14, 2007
(86) PCT No.: PCT/EP2007/009829

§ 371 Date: Jan. 29, 2010

(30) Foreign Application Priority Data
Nov. 14, 2006 (DE) 10 2006 053 480.8

(51) Int. Cl. E04H 12/00; F03D 11/04; B21D 47/01

(52) U.S. Cl. 52/651.01; 29/897.312

(57) ABSTRACT

A hollow section, in particular for a lattice tower, including a first section part and a second section part, wherein the cross-section of the hollow section is formed such that the first section part includes two legs and the second section part is arranged between the legs of the first section part such that, in order to form a closed hollow cross-section, one of the end edges of the second section part is connected to one of the legs and the other end edge of the second section part is connected to the other leg of the first section part such that a partial segment of the particular leg of the first section part projects beyond the connection site.

### BACKGROUND OF THE INVENTION

The present invention relates to a hollow section, in particular for a lattice tower comprising the elements of the preamble of claim 1, a method for the manufacture of a hollow section, as well as a lattice tower comprising at least three corner posts.

The development of wind turbines is such that the dimensions thereof are ever increasing. As a result, the tower carrying the nacelle and the rotor must also have very large dimensions. To date, the towers of wind turbines have been made of steel tubes or prestressed concrete. But these comprise disadvantages. On the one hand, the dimensions of the towers have become so large that the towers can be transported with only great difficulty. On the other hand, the high consumption of material causes towers of such type to be very expensive.

For these reasons, the wind turbines now manufactured include a lattice tower. As a general rule, lattice towers include three to four corner posts which are connected to each other through cross-struts (diagonal members), wherein the corner posts and struts are made of an L-section.

L-sections are a disadvantage in that they can be series-manufactured only up to a specific leg length. The maximum leg length of the largest commercially available L-sections is 260 mm. Due to the predetermined leg length and the open section, the buckling length or bending resistance and torsional strength of L-sections are limited.

This results in the problem that a lattice tower must contain very many struts at short distances between the corner posts, in order to compensate for the short buckling length or bending resistance and torsional strength of the standard L-profiles and in order that the lattice tower can include a load-carrying capacity that is high enough for the developing loads of a wind turbine (subframework). The struts are connected to each other via screwed joints. A very great number of struts (8,000 to 10,000) are required for a lattice tower in which use is made of L-sections. This accordingly results in high assembly costs for the assembly of the tower. The screwed joints are a further disadvantage in that they must be appropriately serviced after completed assembly to detect any detachment of screwed joints in good time.

In contrast to pylons, the tower of a wind turbine is also subject to a considerable dynamic load caused by the nacelle arranged on top of the tower. The upper region of the lattice tower of a wind turbine is predominantly subject to torsional loads, which is why the tower is designed essentially with regard to torsion in its upper region. Torsion plays only a minor role in the lower region of the tower; instead, the loads caused by bending moments are extremely increased. To allow for bending loads, the lower tower floor area is formed very large if L-sections are used for the corner posts because the developing loads can be compensated in this manner. The floor area of a lattice tower comprising L-sections and having a height of more than 100 m is, for example, 23 m×23 m.

For this reason, the use of hollow sections would make particular sense in the manufacture of lattice towers for a wind turbine because said hollow sections include static advantages as compared with standard L-sections. However, usual hollow sections, such as extruded round tubular sections and square sections, are to disadvantage in that, for structural reasons, they can only be joined together with considerable time and effort.

Hollow sections which consist of a first section part and a second section part are known from EP 1 442 807 A1 and FR 921 439 A1, wherein the first section part is a standard L-section. The second section part is formed as a bar and is arranged in the first section part such that a hollow section is formed, wherein one of the longitudinal edges of the bar is welded to one of the legs and the other longitudinal edge of the bar is welded to the other leg.

As a matter of course, the static requirements are considerably better if such a known hollow section is used as corner post for a lattice tower than if a standard L-section were used. Nevertheless, the available dimensions of the standard L-sections required for the manufacture of the known hollow section often do not suffice to allow manufacture of a lattice tower for a wind turbine without the number of struts being extremely high and the tower therefore being accordingly expensive. Or special machines the manufacturing costs of which are enormously high must be used for the production of the hollow section, with the result that the costs for the hollow section become very high in this manner.

Hollow sections for the corner posts of a lifting device are known from EP 1015374, said hollow sections consisting of two parts comprising an angular cross-section of different dimensions, wherein the outer ends of the legs of the smaller one abut against the legs of the bigger one. That means that the two parts of the hollow section are not securely connected to each other. Such a hollow section is not suitable as a corner post for a wind turbine since it would not at all be able to absorb the forces developing during operation of a wind turbine.

### BRIEF SUMMARY OF THE INVENTION

It is, therefore, an object of the present invention to provide a hollow section which can be used as a corner post in a lattice tower and is formed such that the lattice tower, as compared with the known prior art lattice towers, includes a considerably reduced number of struts as well as a considerably reduced lower tower floor area.

This object is achieved by a hollow section including the characterizing elements of claim 1, a method for the manufacture of a hollow section according to claim 12, and a lattice tower according to claim 14.

The hollow section according to claim 1 includes a first section part and a second section part, wherein the cross-section of the hollow section is formed such that the first section part includes two legs and the second section part is arranged between the legs of the first section part such that, in order to form a closed hollow cross-section, one of the end edges of the second section part is connected to one of the legs and the other end edge of the second section part is connected to the other leg of the first section part such that a partial segment of the particular leg of the first section part projects beyond the connection site.

According to the invention, the first and the second section parts are formed such that the ratio of the two areal moments of inertia about the axes of the center of gravity of the area of the cross-section of the hollow section is within a range from 0.9 to 1.6.

Together, the areal moment of inertia and the modulus of elasticity are a measure for the resistance and strength of a flat cross-section against bending and torsion, respectively. In addition, the areal moment of inertia provides information about the tendency of bars to buckle.

The ratio of the two areal moments of inertia about the axes of the center of gravity of the areas is 1 for a tubular section. As is known, tubular sections have better static properties than other hollow sections. For example, a tubular section includes a higher torsional strength and a more favorable stability behavior, more particularly a lower tendency to torsional-flexural buckling. Among other things, this can be attributed to the fact that the cross-section is formed such that developing forces and moments can be absorbed equally well in all regions of the cross-section.

The use of tubular sections is to disadvantage in that they do not include any suitable possibilities of connecting a plurality of sections to each other or stiffening a plurality of sections by means of diagonal members in a simple manner because they do not include any planar areas for connection purposes.

The present invention applies the advantage of a tubular section in an advantageous manner such that, with respect to the ratio of the areal moments of inertia, the value should be approximately 1. As compared with the known tubular section, the hollow section according to the invention, however, is to advantage in that it additionally includes planar areas for connection purposes. Furthermore, the hollow section according to the invention is to advantage in that it consists of two section parts, wherein the variability with respect to the design of the cross-section is considerably improved as compared with standard sections.

The applicant has found out that the use of a hollow section with a ratio of the areal moments of inertia according to the invention allows the formation of a lattice tower which can absorb loads developing in the lattice tower during operation of a wind turbine, wherein the tower is still slender (relatively small tower floor area) and includes a considerably reduced number of struts as compared with the known prior art towers comprising standard L-sections.

According to advantageous embodiments of the invention, the legs of the first section part are arranged at an angle between 60° and 120°. The size of the angle between the legs of the first section part can be selected in relation to the number of corner posts of the lattice tower. It is, thus, advantageous for a 3-post tower to select an angle of 60°. In contrast thereto, however, it is advantageous to form a first section part with an angle of 90° for a 4-post tower.

A further advantageous embodiment of the invention provides that the legs of the first section part are connected to each other via a circular segment.

The provision of a circular segment in the first section part is to advantage in that, in this manner, the cross-sectional shape of the tubular section can be imitated in part, whereby the positive static properties of the tubular cross-section are, accordingly, also applied to the hollow section according to the invention.

If the hollow section according to the invention is used as a corner post of a lattice tower, the circular segments of the first section parts form the outer edges of the lattice tower. The round formation of the edges resulting from the circular segments is to advantage in that the wind resistance and, thus, the noise development as well can be reduced as compared with sharp edges.

According to a further advantageous embodiment of the invention, the ratio of the thickness of the legs to the radius of the circular section is 1:3 for the first section part. Particularly, if the first section part is manufactured by bending, keeping the ratio according to the invention is to advantage in that any metallurgical tensions developing during the bending process can be reduced.

According to further advantageous embodiments of the invention, the second section part also includes two legs which are arranged in relation to each other at an angle between 60° and 120°. Furthermore, the legs of the second section part are connected to each other via a circular segment, wherein the ratio of the thickness of the legs to the radius of the circular segment is 1:3.

A further advantageous embodiment provides that the end edges of the legs of the second section part are bent outwardly at an angle between 110° and 160°.

Furthermore, the present invention relates to a method for the manufacture of a hollow section according to anyone of the preceding embodiments. According to the invention, the first section part is made from a flat steel bar which is bent such that the first section part includes a circular segment comprising two legs extending from the circular segment.

The second section part is, likewise, made from a flat steel bar which is bent such that the second section part includes a circular segment and two legs extending from the circular segment. Adjacent thereto, the outer ends of the legs of the second section part are bent outwardly at an angle between 110° and 160°. Furthermore, a chamfer pointing to the outside at an angle between 70° and 90° is provided at each of the leg end edges of the second section part. The outward bending of the legs and the provision of the chamfer are to advantage in that the making of the future welded connection between the two section parts is facilitated and a weld seam can be generated that withstands the forces subsequently developing during operation of the wind turbine.

Finally, the second section part is arranged in the first section part such that the tips of the chamfers at the leg end edges of the second section part contact the inner edges of the legs of the first section part, and the two section parts are welded to each other.

An embodiment according to the invention of the method provides that the outer ends of the legs of the first section part are, in addition, bent outwardly. This is to advantage in that any thermal deformations of the legs developing while the two section parts are subsequently welded to each other can be compensated.

Furthermore, the present invention relates to a lattice tower for a wind turbine comprising at least three corner posts formed as a hollow section. According to the invention, the hollow section is formed according to anyone of claims 1 to 12.

As has been illustrated in the introduction, the type of load caused by torsion and bending moment changes along the length of the tower. Primarily, torsion must be taken into account in the upper region of the tower and bending moments in the lower region of the tower. In order to meet these requirements, the corner posts are formed according to an advantageous embodiment of the lattice tower such that the ratio of the two areal moments of inertia (Iy, Iz) about the axes (y, z) of the center of gravity of the area of the cross-section of the hollow section (10) varies along the length of the tower.

### BRIEF DESCRIPTION OF THE DRAWINGS

The invention will be illustrated in more detail below by means of FIGS. 1 and 2. In the figures,

FIG. 1 is a schematic diagram of a hollow section according to the invention;

FIG. 2 is a schematic diagram of three hollow sections according to the invention, wherein the first and second section parts are formed such that the ratio of the two areal moments of inertia about the axes of the center of gravity of the area of the cross-section of the hollow section is 1, 1.35 and 1.6.

### DETAILED DESCRIPTION OF THE INVENTION

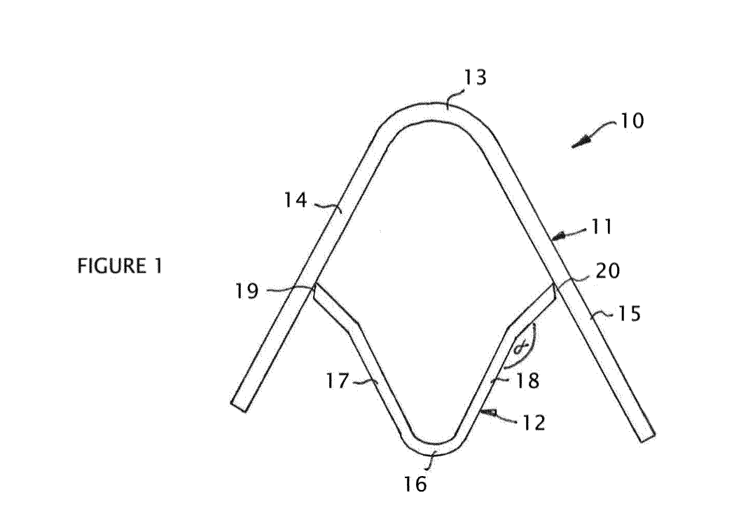

FIG. 1 is a schematic diagram of a hollow section 10 according to the invention, which consists of a first section part 11 and a second section part 12. The first section part 11 includes a circular segment 13. Legs 14, 15 extend from the ends of the circular segment 13.

The second section part 12 also includes a circular segment 16 with legs 17, 18 extending therefrom. The upper ends of the legs 17, 18 are bent at an angle a. A chamfer 19, 20 is provided at each of the edges of the upper leg ends 17, 18.

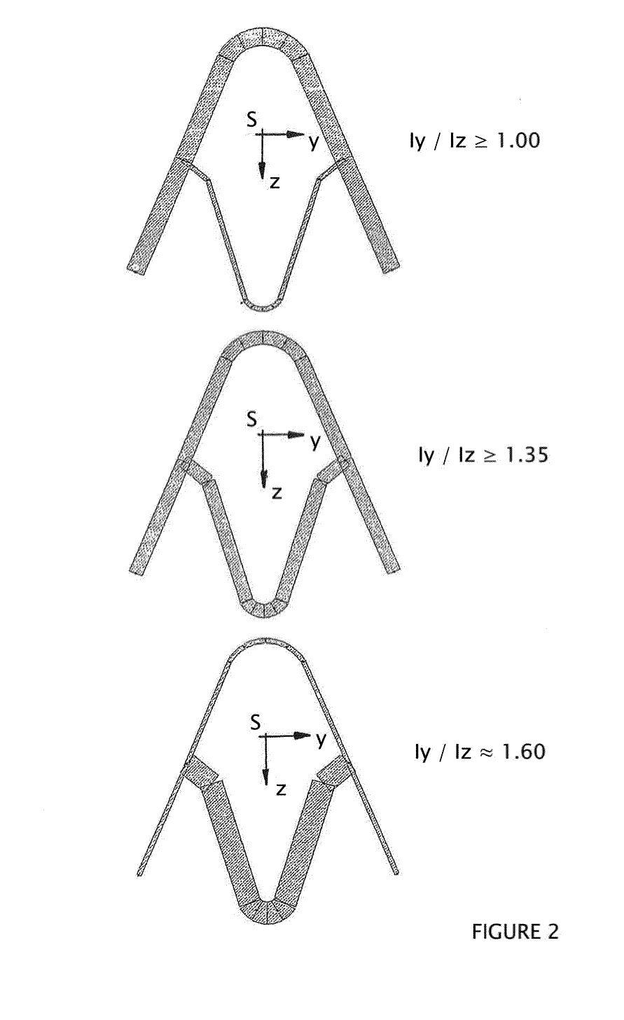

FIG. 2 is a schematic diagram of three hollow sections according to the invention which each include a different ratio of the areal moments of inertia Iy:Iz. The areal moments of inertia are related to the axes y and z of the center of gravity of the area, wherein the two axes are perpendicular to each other in the center of gravity S of the area of the particular hollow section.

The different ratios Iy:Iz of the three hollow sections shown in FIG. 2 are caused by the different section thicknesses of the first and second section parts. For example, the section thickness of the first section part of the upper hollow section is very large as compared with the section thickness of the second section part. Such a hollow section, for example, exhibits a ratio Iy:Iz of ≈1. Such a ratio corresponds to that of a round tube.

In the hollow section in the middle, the section thicknesses of the two section parts are about equally large. In the formation suggested for the hollow section, this results in a ratio Iy:Iz of ≈1.35.

In contrast thereto, the section thickness of the first section part of the lower hollow section is much thinner than that of the second section part. In such a formation of the hollow section, the ratio Iy:Iz is ≈1.6.

1. A hollow section (10), for a lattice tower, comprising:
a first section part (11) and
a second section part (12),
wherein the cross-section of the hollow section (10) is formed such that the first section part (11) includes two legs (14, 15),
wherein the second section part (12) is arranged between the legs (14, 15) of the first section part (11) such that, in order to form a closed hollow cross-section, one of the end edges of the second section part (12) is connected to one of the legs and the other end edge of the second section part (12) is connected to the other leg of the first section part such that a partial segment of the particular leg (14, 15) of the first section part (11) projects beyond the connection site, and
wherein the first and second section parts are formed such that the ratio of the two areal moments of inertia (Iy, Iz) about the axes (y, z) of the center of gravity of the area of the cross-section of the hollow section (10) is within a range from 0.9 and 1.6.

2. The hollow section (10) according to claim 1, wherein the legs (14, 15) of the first section part (11) are arranged at an angle between 60° and 120°.

3. The hollow section (10) according to claim 1, wherein the legs (14, 15) of the first section part (11) are connected to each other via a circular segment (13).

4. The hollow section (10) according to claim 3, wherein the ratio of the thickness of the legs (14, 15) to the radius of the circular segment (13) is 1:3 for the first section part (11).

5. The hollow section (10) according to claim 1, wherein the second section part (12) is formed such that, in the region of the connection sites, the end edges of the second section part (12) are arranged in relation to the legs of the first section part at an angle between 70° and 110°.

6. The hollow section (10) according to claim 1, wherein the second section part (12) includes two legs (17, 18) which are arranged in relation to each other at an angle between 60° and 120°.

7. The hollow section (10) according to claim 6, wherein the legs (17, 18) of the second section part (12) are connected to each other via a circular segment (16).

8. The hollow section (10) according to claim 7, wherein the ratio of the thickness of the legs (17, 18) to the radius of the circular segment (16) is 1:3 for the second section part (12).

9. The hollow section (10) according to claim 6, wherein the end edges of the legs (17, 18) of the second section part (12) are bent outwardly at an angle (α) between 110° and 160°.

10. The hollow section (10) according to claim 1, wherein the section parts (11, 12) are made from flat steel.

11. The hollow section (10) according to claim 1, wherein the section parts (11, 12) are welded to each other.

12. A method for the manufacture of a hollow section (10) according to claim 1, wherein
the first section part (11) is made from a flat steel bar which is bent such that the first section part (11) includes a circular segment (13) comprising two legs (14, 15) extending from the circular segment (13),
the second section part (12) is made from a flat steel bar which is bent such that the second section part (12) includes a circular segment (16) and two legs (17, 18) extending from the circular segment (16),
the outer ends of the legs (17, 18) of the second section part (12) are bent outwardly at an angle between 110° and 160°,
a chamfer (19, 20) pointing to the outside at an angle between 70° and 90° is provided at each of the leg end edges of the second section part (12),
the second section part (12) is arranged in the first section part (11) such that the tips of the chamfers (19, 20) at the leg end edges of the second section part (12) contact the inner edges of the legs of the first section part (11),
the two section parts (11, 12) are welded to each other.

13. The method according to claim 12, wherein the ends of the legs (14, 15) of the first section part (11) are bent outwardly prior to welding.

14. A lattice tower comprising at least three corner posts for a wind turbine, which are formed as hollow section (10), wherein the hollow section (10) is formed according to claim 1.

15. The lattice tower for a wind turbine according to claim 14, wherein the corner posts are formed such that the ratio of the two areal moments of inertia (Iy, Iz) about the axes (y, z) of the center of gravity of the area of the cross-section of the hollow section (10) varies along the length of the tower.
